(19) United States
(12) Patent Application Publication
(10) Pub. No.: US 2025/0050623 A1
(43) Pub. Date: Feb. 13, 2025

(54) WINDSHIELD WITH IMPROVED IMPACT PROTECTION

(71) Applicant: SAINT-GOBAIN GLASS FRANCE, COURBEVOIE (FR)

(72) Inventors: Emmanuel WALCH, HERZOGENRATH (DE); Martin LAKSHMANAN, HERZOGENRATH (DE); Malte LINN, HERZOGENRATH (DE)

(21) Appl. No.: 18/721,409

(22) PCT Filed: Dec. 13, 2022
(86) PCT No.: PCT/EP2022/085551

§ 371 Date: Jun. 18, 2024

(30) Foreign Application Priority Data
Dec. 20, 2021 (EP) 21215827.3

(51) Int. Cl. B32B 17/10; B32B 1/00

(52) U.S. Cl. CPC B32B 17/10183; B32B 1/00; B32B 17/10036; B32B 17/10119; B32B 17/10467; B32B 17/10761; B32B 2250/03; B32B 2250/40; B32B 2255/20; B32B 2264/1021; B32B 2264/2031; B32B 2307/412; B32B 2307/7376; B32B 2315/08; B32B 2329/06

(57) ABSTRACT

A windshield having an engine edge, a roof edge, and two side edges running between them, includes an outer pane made of glass with an outer surface and an interior-side surface and an inner pane made of glass with an outer surface and an interior-side surface, wherein the interior-side surface of the outer pane and the outer surface of the inner pane are connected to one another via a thermoplastic intermediate layer, and the windshield includes a first partial region, in which a transparent cover print including enamel is applied to the outer pane and/or inner pane, the first partial region is arranged along the engine edge and extends from the engine edge in the direction of the roof edge of the windshield, and the windshield has a transmission of at least 70% in the visible range of the light spectrum in the first partial region, at least in portions.

The invention relates to a windshield with improved impact protection, a method for the production thereof, and to the use thereof.

Composite panes, which comprise at least two panes and at least one polymer film adhesively bonded between the panes, have been used for decades in large quantities in various technical fields, in particular in building glazing and in vehicle construction. The selection of the materials used and the dimensioning of the components takes place as a function of the requirements of the specific intended purpose, in particular with regard to the desired mechanical load-bearing capacity of the finished glazing, taking into account the boundary conditions set by the framing and any attachments.

U.S. Pat. No. 3,437,552 A discloses composite panes comprising two glass panes and an intermediate polyvinyl butyral (PVB) layer.

U.S. Pat. No. 6,708,595 B1 discloses an armored composite glass pane for motor vehicles, which comprises a stack sequence of a plurality of panes and a plurality of adhesive intermediate layers between them.

DE 4013300 A1 discloses a windshield with a filter belt, wherein the filter belt damps light and heat radiation and comprises a transparent coating made of a baking ink that contains a colloidally distributed noble metal.

In the automotive industry in particular, there is a trend towards the use of thinner and therefore lighter glass in composite glass panes as part of efforts to reduce weight and thus achieve fuel and electricity savings. Nevertheless, such glazings must meet defined mechanical requirements that are fixed in relevant industrial standards. This not only increases safety requirements for vehicle occupants, but also for other road users, such as pedestrians. In the event of a head-on collision between a pedestrian and a car, the pedestrian is very likely to hit the hood of the car, causing their head to hit the windshield of the car. This can result in severe or even fatal injury to the pedestrian, in particular if their head smashes through the windshield and hits other objects such as the dashboard.

Therefore, the invention is based on the object of providing an improved windshield that, on the one hand, offers greater accident safety for passers-by and, on the other hand, ensures compliance with the relevant standards for windshields with regard to stone impact resistance and transparency.

According to the proposal of the invention, this object is achieved by a windshield according to claim 1. Advantageous embodiments of the invention emerge from the dependent claims.

The windshield according to the invention comprises at least one outer pane and one inner pane, which are connected to one another by means of a thermoplastic intermediate layer. Both panes are made of glass. The peripheral edge of the windshield has four portions that, in relation to the installation location of the windshield in a motor vehicle, are referred to as the engine edge, roof edge and side edges, wherein two opposing side edges connect the engine edge and the roof edge. The outer pane has an outer surface I and an interior-side surface II. The inner pane has an outer surface III and an interior-side surface IV. In the installed state of the windshield, the outer surfaces of the panes in a motor vehicle face the vehicle surroundings, while the surfaces on the interior side in each case designate the surfaces of the panes facing the vehicle interior. The interior-side surface II of the outer pane is connected to the outer surface III of the inner pane via the thermoplastic intermediate layer. The windshield has at least a first partial region that extends in the direction of the roof edge adjacent to the engine edge of the windshield. In this first partial region, the outer pane and/or the inner pane have a transparent cover print comprising enamel. The windshield has a transmission of at least 70% in the visible range of the light spectrum in the first partial region. The cover print projects at least partially into the A field of view of the windshield according to ECE-R 43, Annex 3, Section 9.1 Method for testing the light transmission of motor vehicle panes. In the A field of view, a transmission of at least 70% in the visible range of the light spectrum is required for windshields.

The transparent cover print differs from the opaque cover prints commonly used in the automotive sector due to its transparent design; i.e., objects can also be seen in the through-view direction through the windshield in the region of the transparent cover print in the through-view through the windshield. The windshield is thus largely transmissive to radiation of the visible spectrum in the first partial region in which the transparent cover print is applied.

The inventors have found that the windshield in the first partial region has improved breakage characteristics when an object hits the windshield. The first partial region is the region adjacent to the engine edge, in which region a pedestrian's head is more likely to hit in the event of an accident. It is known that enamel applied to glass reduces the strength of the glass. The inventors have made use of this generally undesirable effect to influence the breakage characteristics of the windshield. The targeted weakening of the outer pane and/or inner pane of the windshield leads to early breakage in the event of a body impact. After one or both of the glass panes break, a considerable amount of energy is absorbed due to the expansion of the thermoplastic intermediate layer and the at least partial delamination in the region of the broken glass panes. The thermoplastic intermediate layer is expandable and therefore yields, so that the head slows down less abruptly and experiences a lower deceleration rate. An abrupt deceleration of the head, as occurs in the case of a late glass breakage, should be avoided. A windshield not according to the invention without a transparent cover print shows a late glass breakage in the event of a head impact, wherein a large part of the kinetic energy of the impact is dissipated by the bending of the glass, which leads to a high deceleration rate of the head. In order to quantify this head impact, the head injury criterion (HIC) is used, for example, which assesses the severity of an impact based on the deceleration rate of the head. High deceleration rates are usually associated with high HIC values, which are associated with severe injuries to the head of the pedestrian. A low HIC value is equivalent to a low risk for severe head injuries. In the regions of the transparent cover print, defects in the glass are specifically introduced in the form of regions of lower strength. As a rule, a glass breakage always begins at a defect in the glass if tensile stress is exerted in this region. Minor statistically distributed defects can be detected in glass panes due to the production process. However, their influence on the breaking behavior is not predictable due to the statistical distribution of such natural defects. In contrast to the random defects in the glass, the defects introduced according to the invention in the first partial region of the windshield via the transparent cover print can be specifically placed in the first partial region of the windshield as the region in which early breakage is to occur. As a result, the windshield according to the invention also offers greater safety for a passer-by in the event of a traffic accident involving the passer-by, since the severity of the impact of the human head in the event of a head-on collision is mitigated by early breakage of the windshield.

In the first partial region, the windshield has a transmission in the visible range of the light spectrum of at least 70%, at least in portions. In particular in the main field of view of the windshield, also referred to as the A-field, a transmission of at least 70% in the visible range is required to meet the statutory regulations for windshields (ECE-R 43, Annex 3, Section 9.1 Method for testing the light transmission of motor vehicle panes). In the region in which the first partial region projects into the main field of view of the windshield, there is a transmission of 70%; in other regions a lower transmission is also sufficient.

The transmission of the windshield in the first partial region is influenced, for example, by the transparency of the enamel of the transparent cover print itself and by a full-surface or partial-surface application of the enamel of the transparent cover print. In principle, the larger the region of the enamel of the transparent cover print, the greater the transparency of the enamel itself should be. In order to produce transparent cover prints with a low-transparency enamel, the enamel is used in small regions, so that the transparent cover print as a whole has the desired transparency. In this way, transparent cover prints can be obtained that do not interfere with the visual appearance in the through-view through the pane. The enamel of the transparent cover print is preferably colorless and particularly preferably transparent or translucent, in particular the enamel has a transmission of at least 20%, preferably at least 40%, in particular at least 50% of the visible light.

The windshield is provided for separating a vehicle interior from the external surroundings. The windshield is therefore a window pane that is inserted into a window opening in the vehicle body or is provided for this purpose. The windshield is recessed between the hood, the body roof and the A-pillars of the vehicle body in the opening provided in the body. The edge of the windshield closest to the engine region of the vehicle in the installed state is referred to as the engine edge, while the edge opposite the engine edge is called the roof edge and is oriented adjacent to the vehicle roof. The two edges of the windshield that run adjacent to the A-pillars are referred to as the side edges of the windshield and connect the engine edge and the roof edge. The first pane is the outer pane of the windshield, which faces the vehicle surroundings, while the second pane of the windshield is the inner pane, which is oriented to the vehicle interior. It is understood that the first pane, the second pane and the thermoplastic intermediate layer have substantially the same outer dimensions. The surface of the respective pane that faces the external surroundings of the vehicle in the installed position is referred to as the outer surface. The surface of the respective pane that faces the interior of the vehicle in the installed position is referred to as the interior-side surface. The interior-side surface of the outer pane is connected to the outer surface of the inner pane via the thermoplastic intermediate layer. Typically, the outer surface of the outer pane is referred to as “side I”, the interior-side surface of the outer pane as “side II”, the outer surface of the inner pane as “side III” and the interior-side surface of the inner pane as “side IV”.

The windshield according to the invention has a first surface region, referred to as the first partial region. This first partial region comprises at least a portion of the surface area of the windshield, but can also comprise the entire pane surface of the windshield. If the first partial region covers less than the entire pane surface of the windshield, the surface region not covered by the first partial region is referred to as the second partial region of the windshield. The second partial region comprises regions in which no transparent cover print is applied. A plurality of first partial regions and/or second partial regions can also be present, wherein the first partial regions comprise a transparent cover print, while the second partial regions are free of a transparent cover print. In a preferred embodiment, the windshield has only a first partial region and a second partial region, which together cover the total area of the windshield.

The thermoplastic intermediate layer can comprise one or more other films. These can be, for example, films that have electrically switchable functions or colored regions. The thermoplastic intermediate layer can have a single-layer or multi-layer structure. In one possible embodiment, the thermoplastic intermediate layer is designed as a film laminate, for example as a film laminate having three layers.

Preferably, the first partial region takes up between 10% and 100%, preferably 20% to 90%, particularly preferably 30% to 70%, of the total area of the windshield. Tests have shown that the mentioned preferred surface portions of the first partial region are sufficient to achieve good safety in the head impact test.

Preferably, the first partial region extends at least in portions from the engine edge of the windshield by an amount in the direction of the roof edge of the windshield that corresponds to 10% to 90%, preferably 20% to 70% of the height of the windshield. The height of the windshield is determined by measuring the shortest distance to the roof edge at the relevant position of the engine edge. Subsequently, the amount by which the first partial region extends in the direction of the roof edge is determined at the same position of the engine edge as the shortest distance between the engine edge and the upper edge of the first partial region offset in the direction of the roof edge, as a result of which the height of the first partial region arises at this position along the engine edge. This height of the first partial region is set in relation to the height of the windshield, measured in each case at the same position along the windshield, thereby obtaining the relative amount by which the first partial region extends from the engine edge in the direction of the roof edge. The height up to which the first partial region extends is determined as a function of the vehicle geometry, wherein the region in which the head of a pedestrian would most likely hit in the event of an accident is preferably located in the first partial region. The first partial region is attached adjacent to the engine edge and extends from there, at least in portions, up to the mentioned height of the windshield. “In portions” means that the first partial region projects into the windshield in at least one portion along the engine edge of the windshield up to the specified height in the direction of the roof edge, but can also have a lower height in other portions. The upper edge of the first partial region, i.e., the edge portion of the first partial region that has the greatest distance from the engine edge of the windshield, preferably runs in a straight or curved line between the side edges of the windshield.

In a particularly preferred embodiment, the size of the first partial region is selected such that, in the installed state of the windshield in a motor vehicle, the size of the first partial region corresponds to at least 90% of the area of the projection of the dashboard of the motor vehicle onto the windshield. Particularly preferably, the size of the first partial region corresponds to at least the area of the projection of the dashboard onto the windshield. A common accident scenario involving pedestrians is that the pedestrian's head hits the windshield in the region of the dashboard. If the windshield is broken in this region, the pedestrian's head hits the dashboard behind it directly, wherein the likelihood of severe injury is increased. In this respect, it is advantageous to design the region of the windshield, which is covered by a projection of the dashboard onto the windshield in the installed state, as the first partial region, as a result of which the windshield breaks at an early stage. Preferably, the invention is thus implemented as a motor vehicle comprising a windshield according to the invention, wherein the first partial region of the windshield corresponds to at least 90%, preferably at least 100%, of the area of the projection of the dashboard of the motor vehicle onto the windshield.

The transparent cover print is applied to the outer pane and/or the inner pane. As a result, one or both panes of the windshield are weakened in a targeted manner in order to bring about early breakage. The severity of the impact is reduced by the early breaking of the windshield. After the glass breaks, a considerable amount of energy is absorbed due to the expansion of the thermoplastic intermediate layer and the partial delamination of the broken glass fragments. By the expansion of the thermoplastic intermediate layer, the human head is subjected to a somewhat lower deceleration rate. Very abrupt head decelerations, as occur in the case of a late glass breakage, are avoided. The transparent cover print is preferably applied to the interior-side surface of the outer pane and/or the interior-side surface of the inner pane. Windshield breakage is not caused directly by the impact of an object on the outer side of the windshield, but by the tensile stress that occurs in the glass, particularly on the interior-side surfaces of the outer pane and the inner pane. This is the case in particular with semi-hard objects, such as a human head. The windshield first breaks at the points at which the tensile stress is greatest. If an impact occurs on the outer surface of the outer pane, the greatest tensile stresses arise on the interior-side surface of the outer pane and on the interior-side surface of the inner pane. If the transparent cover print is applied to one of these surfaces, the desired early breakage occurs there. Particularly preferably, the transparent cover print is attached at least to the interior-side surface of the inner pane. On the one hand, the highest tensile stresses arise on this surface, on the other hand, it is an easily accessible, easily printable pane surface.

The transparent cover print can be full-surface or partial-surface within the first partial region. The transparent cover print is preferably designed to be partial-surface; i.e., it contains printed regions and at least one non-printed region. The printed regions are referred to as print regions, while the at least one non-printed region represents the non-print region. If only one non-print region is present, it extends as a contiguous region between the print regions and surrounds the print regions. A plurality of non-print regions, which are separated from one another by one or more print regions, can also be present. A partial-surface design of the transparent cover print with print regions and non-print regions is advantageous in order to improve the transparency of the pane and to be able to better control breakage patterns. A partial-surface application of the transparent cover print has proven to be completely sufficient to cause the desired early breakage of the pane. Preferably, the print regions are designed to be punctiform, elliptical, cross-shaped or rectangular. In this way, the print areas can be distributed particularly inconspicuously, wherein the transparency of the windshield is only slightly affected. Rounded corners of the print regions or round or elliptical print regions have proven to be advantageous to ensure the most precise imprint possible.

The print regions of the transparent cover print preferably take up a proportion of 1% to 60%, particularly preferably 5% to 50%, in particular 10% to 40%, of the total area of the second partial region. This proportion has proven to be sufficient in head impact tests to achieve the desired early breakage of the outer pane. Preferably, the print regions form a regular or irregular pattern, which can be used to control the breakage pattern as a function of the geometry of the windshield.

Particularly preferably, the print regions form a regular or irregular pattern, wherein print regions adjacent to one another have an average distance from 1 cm to 50 cm, preferably from 2 cm to 30 cm, particularly preferably from 3 cm to 15 cm, for example from 5 cm to 10 cm. A print region is adjacent to one or more other print regions if no other print region(s) is/are at a lesser distance from one another. In other words, adjacent print regions are the print regions that are closest to one another and are separated from one another by a non-print region. This has proven to be advantageous so that a head hitting the windshield always strikes near a print region in the first partial region. Particularly preferably, the print regions form a regular dot pattern, wherein adjacent points have a distance from 1 cm to 50 cm, preferably from 2 cm to 30 cm, particularly preferably from 3 cm to 15 cm, for example from 5 cm to 10 cm. A point is adjacent to one or more other points if no other point(s) is/are at a lesser distance from one another. In other words, adjacent points are the points closest to one another and are separated from one another by a non-print region. The points represent the print regions and are surrounded by a contiguous non-print region. Such a regular pattern is easy to apply, for example with screen printing methods, and advantageously in order to ensure a reliable breakage of the pane at all positions within the first partial region. Screen printing methods have proven to be particularly advantageous for application in accordance with the invention.

The diameter of the print regions is preferably 0.1 mm to 10 mm. This made it possible to achieve reliable breakage of the pane, while at the same time keeping the print region small in order to save costs and avoid visual impairments. Print regions with a diameter of 0.2 mm to 5.0 mm, in particular 0.2 mm to 3.0 mm, for example 0.3 mm to 1.0 mm, have proven to be particularly preferred. Print regions of this size are visually very inconspicuous for the driver of the vehicle and, in tests by the inventors, lead to the desired early breakage of the windshield.

In one possible embodiment, the surface portion of the print regions within the first partial region decreases from the engine edge in the direction of the roof edge. Adjacent to the upper edge of the first partial region, the surface portion of the print regions per surface unit is thus lower than the surface portion of the print regions per surface unit adjacent to the engine edge. In this way, a step-by-step transition between the first partial region and a non-printed second partial region adjacent thereto can be created.

The transparent cover print is preferably a printed enamel containing SiO₂, particularly preferably containing SiO₂, Bi₂O₃ and ZnO. Enamels comprising these constituents are known and are produced, for example, by baking printing pastes into glass surfaces. Suitable printing pastes for automotive glazings and building glazings are commercially available and, in addition to the constituents mentioned, generally contain solvents along with pigments. The solvent evaporates during the baking process and is no longer present in the resulting enamel. The pigments contained in commercially available printing pastes are used to color the pane from an aesthetic point of view. Black pigmented printing pastes are also used for the opaque cover print common in the automotive sector in windshields and rear windows in the edge region along the peripheral edge. The basic composition of these known printing pastes is suitable for producing the transparent cover print according to the invention, although all pigments are preferably omitted for an application according to the invention.

Within the print regions, the cover print applied in the first partial region leads to a reduction in strength of the glass in contact with the cover print. During the baking on of the printing paste, pores form in the resulting enamel, which transfer a defect site corresponding to the respective pore to the underlying glass and thus lead to the desired reduction in strength. A particularly advantageous breaking behavior could be determined if the printed enamel has pores of the size of 0.5 μm to 5 μm, particularly preferably 2.0 μm to 4.0 μm. Methods for determining the pore size are known to the person skilled in the art. For example, electron microscopy can be used to determine the pore size. Preferably, an FIB (focused ion beam) method is used. In the present case, the pore sizes were determined using dual-beam FIB nanotomography. This technique enables the reconstruction and analysis of a three-dimensional material volume with a very high resolution.

The edge portion of the first partial region that has the greatest distance from the engine edge along the engine edge is referred to as the upper edge of the first partial region. The edge of the first partial region is a line enclosing the first partial region with a cover print. The upper edge of the first partial region preferably extends between the side edges of the windshield, wherein the upper edge can, but does not have to, end at the side edges of the windshield. This means that the upper edge can meet the respective side edge on one or both side edges of the windshield.

In principle, the first partial region can have any shape and preferably has the shape of a rectangle or a rounded rectangle or a semicircle or a semi-ellipse, in each case adjacent to the engine edge of the windshield. Depending on the geometry of the windshield, other forms are also expedient.

In a preferred embodiment, the upper edge of the first partial region runs in a straight line between the side edges and ends at the side edges of the windshield. For a straight-line upper edge, a course horizontal in the installed state of the windshield in the vehicle has proven to be advantageous in order to achieve the desired reduction in strength in the first partial region uniformly in all regions along the engine edge. In a further preferred embodiment, the upper edge of the first partial region has a curved profile. The upper edge can end in the region of the side edges or can also run towards the corner regions and end directly in the corner region or at the portions of the engine edge adjacent to the corner region. This results in a semicircular or semi-elliptical geometry of the first partial region.

The thermoplastic intermediate layer preferably comprises polyvinyl butyral (PVB), polyurethane (PU), ionomers and/or ethylene vinyl acetate (EVA), particularly preferably PVB. These materials have proven to be particularly suitable with regard to a secure connection of the panes to one another.

The thickness of the thermoplastic intermediate layer is preferably between 300 μm and 1000 μm, particularly preferably between 500 μm and 900 μm, in particular between 650 μm and 850 μm.

The outer pane and the inner pane are made of glass, preferably soda-lime glass, as is customary for window panes. However, the panes can also be manufactured from other types of glass, for example quartz glass, borosilicate glass or aluminosilicate glass.

Independently of one another, the outer pane and the inner pane can be made of non-prestressed, partially prestressed or prestressed glass. If the outer pane and/or the inner pane are to be prestressed, this can be a thermal or chemical prestressing.

The outer pane and the inner pane in each case preferably have a thickness of 0.8 mm to 2.5 mm, particularly preferably from 1.2 mm to 2.2 mm. The thickness of the outer pane is typically from 1.0 mm to 2.5 mm. The thickness of the inner pane is preferably between 0.8 mm and 2.1 mm. The thickness of the outer pane is preferably greater than the thickness of the inner pane. For example, the outer pane can be 2.1 mm thick and the inner pane 1.1 mm thick, or the outer pane 1.8 mm thick and the inner pane 1.4 mm thick, or the outer pane 1.6 mm thick and the inner pane 1.1 mm thick, or the outer pane 1.6 mm thick and the inner pane 0.7 mm thick, or the outer pane 1.4 mm thick and the inner pane 1.1 mm thick.

The inner pane, the outer pane and the thermoplastic intermediate layer can be clear and colorless, but can also be tinted or colored. The tinting of the outer pane, inner pane and of the thermoplastic intermediate layer is selected as a function of the desired application of the composite pane. For windshields, high transmission in the visible range of the light spectrum is desired and dark tinting of the components is omitted. In one embodiment of the windshield for a motor vehicle, the total transmission through the windshield is greater than 70%, based on light type A. The term “total transmission” relates to the method defined by ECE-R 43, Annex 3, Section 9.1 for testing the light transmission of motor vehicle panes.

The windshield according to the invention is preferably curved in one or more spatial directions, as is usual for windshields of motor vehicles, wherein the typical radii of curvature are in a range of approximately 10 cm to approximately 40 m. However, the windshield can also be flat, for example if it is provided as a pane for buses, trains or tractors.

The inner pane, the outer pane, and/or the thermoplastic intermediate layer can have further suitable coatings known per se, e.g., anti-reflective coatings, non-stick coatings, anti-scratch coatings, photocatalytic coatings or sun protection coatings or low-E coatings.

Automotive glazings, in particular windshields, rear windows, and roof panes, usually have a peripheral cover print made of an opaque enamel, which in particular serves to protect and optically cover the adhesive used for installing the pane from UV radiation. Preferably, at least the outer pane has such an opaque peripheral cover print, particularly preferably both the outer pane and the inner pane are printed, so that the through-view from either side is prevented. The opaque cover print is applied in the form of a screen print, for example, so that this screen print circumscribes the field of view of the pane or forms its outer edge. An electrical conductor that may be arranged in the edge region of the pane and, in the case of coated panes, an optionally provided coating-free edge region are preferably covered by this cover print and are therefore optically concealed. The opaque screen print can be applied in any plane of the windshield.

The invention further comprises a method for producing a windshield according to the invention, which comprises the following method steps:
a) providing an outer pane or an inner pane,
b) placing a thermoplastic intermediate layer onto the outer pane or the inner pane,
c) closing off the layer stack with an inner pane or an outer pane with a transparent cover print and
d) laminating the layer stack composed of at least the outer pane, thermoplastic intermediate layer and inner pane to form a windshield, wherein a transparent cover print is applied to the outer pane and/or the inner pane.

The transparent cover print is preferably applied to the outer pane and/or the inner pane prior to step a). Particularly preferably, the transparent cover print is applied in the screen printing method and baked on prior to step a). Screen printing methods are known to a person skilled in the art. A particularly advantageous reduction in strength within the print regions was observed with transparent cover prints applied in the screen printing method.

The thermoplastic intermediate layer can also be placed in the form of a plurality of films, for example two or more thermoplastic films.

If coatings, such as solar control coatings or heatable coatings, are to be applied to the surfaces of the first pane and the second pane facing the thermoplastic intermediate layer, the panes are preferably connected to form the laminated glass after the coating has been applied. If the windshield comprises coatings that are to be electrically contacted, the electrically conductive layers are electrically contacted via busbars or other suitable electrical conductors before the composite pane is laminated.

Any opaque cover prints applied to the edge of the windshield are preferably applied using the screen printing method. If an opaque cover print and the transparent cover print are to be applied to the same pane surface, they are preferably applied one after the other.

The outer pane and inner pane are connected via the thermoplastic intermediate layer to form the windshield, preferably by lamination under the effect of heat, vacuum and/or pressure. Methods known per se for producing a composite pane can be used. During lamination, the heated, flowable thermoplastic material flows, so that a stable bond is produced.

For example, so-called autoclave methods can be carried out at an elevated pressure of approximately 10 bar to 15 bar and at temperatures of 130° C. to 145° C. for approximately 2 hours. Vacuum bag or vacuum ring methods known per se operate, for example, at approximately 200 mbar and 80° C. to 110° C. The outer pane, the thermoplastic intermediate layer, and the inner pane can also be pressed in a calender between at least one pair of rollers to form a pane. Systems of this type are known for producing panes and normally have at least one heating tunnel upstream of a pressing unit. The temperature during pressing is, for example, from 40° C. to 150° C. Combinations of calender and autoclave methods have proven particularly successful in practice. Vacuum laminators can be used as an alternative. These consist of one or more heatable and evacuable chambers, in which the panes are laminated within, for example, approximately 60 minutes at reduced pressures of 0.01 mbar to 800 mbar and temperatures from 80° C. to 170° C.

The invention further comprises the use of the windshield according to the invention in motor vehicles, particularly preferably in a passenger car. The invention can also be used for contiguous panoramic glazing in which the windshield comprises a partial region of the roof.

All the standards mentioned relate to their version valid as on the filing date of the invention.

The various embodiments of the invention may be implemented individually or in any combinations. In particular, the features mentioned above and yet to be explained below can be used not only in the specified combinations but also in other combinations or alone without departing from the scope of the present invention. That is the case unless exemplary embodiments and/or their features are explicitly mentioned only as alternatives or are mutually exclusive.

The invention will be illustrated in more detail below with reference to the drawings. It should be noted that different aspects are described, each of which can be used individually or in combination. In other words, any aspect may be used with different embodiments of the invention unless explicitly presented as a pure alternative.

The drawings are purely schematic representations and are not true to scale. The drawings do not limit the invention in any way.

In the figures:

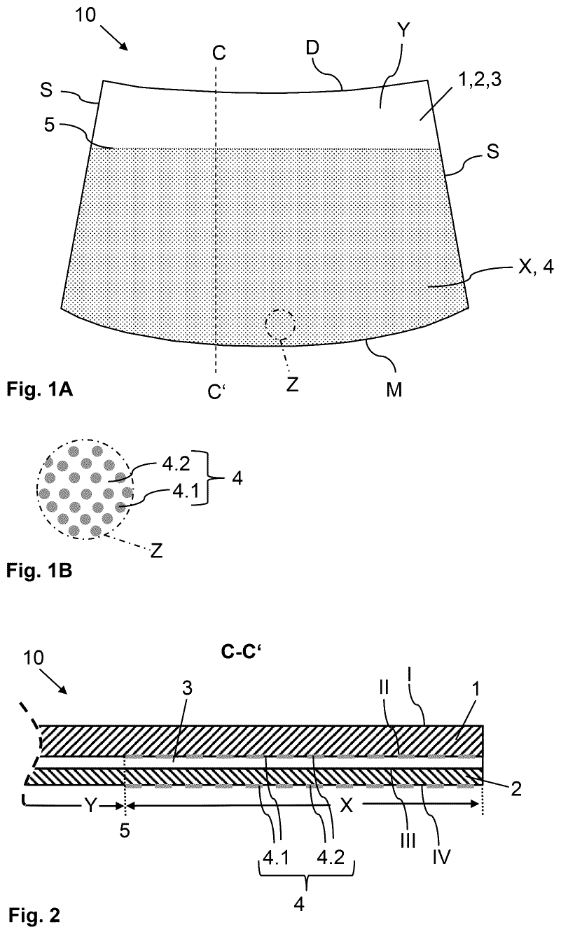

FIG. 1a, b show a top view of an embodiment of a windshield according to the invention,

FIG. 2 shows a section of a cross-section through the embodiment of a windshield according to the invention shown in FIG. 1, and

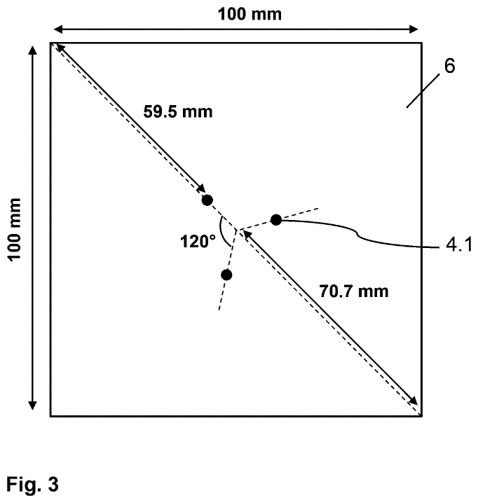

FIG. 3 shows a sample with a transparent cover print consisting of three punctiform print regions for examining the flexural strength of glass with enamel print.

FIG. 1a, b shows the top view of an embodiment of a windshield 10 according to the invention, while FIG. 2 shows a section of a cross-section through the embodiment shown in FIG. 1 along the section line C′-C according to FIG. 1. FIG. 1b shows an enlarged view of the region Z of the windshield according to the invention from FIG. 1a.

The windshield 10 shown in FIGS. 1a, b and 2 comprises an outer pane 1 and an inner pane 2, which are connected to one another by a thermoplastic intermediate layer 3. The outer pane 1 has an outer surface I and an interior-side surface II. The inner pane 2 has an outer surface III and an interior-side surface IV. In the installed state of the windshield 10, the outer surfaces I, III point in the direction of the surroundings, while the interior-side surfaces II, IV are oriented in the direction of the vehicle interior in the installed state. The interior-side surface II of the outer pane 1 is connected to the outer surface III of the inner pane 2 via the thermoplastic intermediate layer 3. The windshield 10 has a roof edge D, an engine edge M opposite the roof edge and two side edges S opposite one another, which connect the engine edge M and the roof edge D to one another. The windshield 10 has a first partial region X and a second partial region Y, wherein the first partial region X is arranged adjacent to the engine edge M.

As can be seen from FIGS. 1a and 2, a transparent cover print 4 is arranged in the first partial region X of the windshield 10. The remaining surface region of the windshield 10 is referred to as the second partial region Y and is completely free of such a transparent cover print 4. The outer pane 1 is, for example, a glass pane made of soda-lime glass with a thickness of 2.1 mm. The inner pane 2, for example, is made of soda-lime glass and has a thickness of 1.6 mm.

The first partial region X has an upper edge 5 that, starting from the engine edge M, is arranged offset in the direction of the roof edge D. The upper edge 5 of the first partial region X runs between the side edges K, wherein the transparent cover print 4 is applied between the upper edge 5 of the first partial region X and the engine edge M. A transparent cover print 4 is arranged on the interior-side surface IV of the inner pane 2. This has proven to be particularly advantageous for achieving early breakage of the windshield 10 in the head impact test. Further improved results can be achieved if, as shown in FIG. 2, a transparent cover print 4 is additionally arranged on the interior-side surface II of the outer pane 1. The transparent cover prints 4 on the inner pane 2 and the outer pane 1 have punctiform print regions 4.1, which are surrounded by a contiguous non-print region 4.2 in each case.

The inventors have carried out tests that experimentally confirm a targeted weakening of a glass pane in the region of a transparent cover print according to the invention. For this purpose, the inventors carried out tests with float glass panes with a thickness of 1.6 mm and a size of 1100 mm×500 mm. A series of such samples was printed with a cover print 4 consisting of three enamel points as print regions 4.1, wherein the size of the points was varied. The cover print 4 was applied to the so-called fire side of the float glass pane. Glass produced in float glass methods has different surface characteristics and stresses on the opposite surfaces of the float glass pane. A distinction is made between the so-called bath side of the float glass pane, which refers to the glass surface that was in contact with the tin bath, and the so-called fire side, which refers to the remaining opposite glass surface. FIG. 3 shows the position of the punctiform print regions 4.1 on the fire side of a sample. The sample shown in FIG. 3 is a glass pane 6 consisting of float glass. The samples were printed with a screen-printing paste in the screen printing method, which produces an enamel in the print regions after the printed paste has been baked on.

The samples were subjected to a flexural strength test in accordance with DIN EN 1288-5, wherein the flexural strength was examined using the Weibull distribution. Table 1 shows the average characteristic Weibull strength of samples 1 to 5 with print regions of variable size on the fire side of the sample compared to the flexural strength of two untreated comparative samples on the fire side (comparative sample V1) and the bath side (comparative sample V2). The comparative samples differ from samples 1 to 5 only by the absence of the transparent cover print. Table 1 also shows the number of samples examined in each case and the shape parameter m of the Weibull distribution. Weibull distributions with a shape parameter m greater than 1 are used to examine fatigue and wear failures and also represent the present breakage scenario of the pane.

TABLE 1

| | | | | | | Comparative | |
|---|---|---|---|---|---|---|---|
| | Samples | | | | | samples | |
| | #1 | #2 | #3 | #4 | #5 | V1 | V2 |
| Number of | 9 | 14 | 13 | 10 | 11 | 15 | 15 |
| samples | | | | | | | |
| Diameter of | 0.5 | 1.0 | 2.0 | 5.0 | 10.0 | — | — |
| print regions | | | | | | | |
| in mm | | | | | | | |
| Shape | 3.52 | 3.97 | 3.00 | 4.80 | 58.23 | 3.85 | 4.30 |
| parameter m | | | | | | | |
| Weibull | 186.2 | 125.4 | 83.6 | 52.4 | 39.0 | 541.2 | 232.4 |
| strength σ₀ | | | | | | | |
| in N/mm² | | | | | | | |

As can be seen in Table 1, a substantial reduction in flexural strength can be observed in all samples compared to the comparative samples. Such an improvement is also to be expected on impact of a pedestrian in the first partial region X with a cover print 4. Print regions with a diameter of 0.5 mm have proven to be particularly advantageous in order to make them as visually inconspicuous as possible and to ensure a high transmission of the pane.

### LIST OF REFERENCE SIGNS

10 Windshield
1 Outer pane
2 Inner pane
3 Thermoplastic intermediate layer
4 Transparent cover print
4.1 Print regions
4.2 Non-print regions
5 Upper edge of the first partial region X
6 Glass pane, sample
X First partial region
Y Second partial region
D Roof edge
M Engine edge
S Side edges
Z Section shown in large detail
CC′ Section line
I Outer surface of the outer pane 1
II Interior-side surface of the outer pane 1
III Outer surface of the inner pane 2
IV Interior-side surface of the inner pane 2

1. A windshield having an engine edge, a roof edge, and two side edges running between them, at least comprising an outer pane made of glass with an outer surface and an interior-side surface and an inner pane made of glass with an outer surface and an interior-side surface, wherein the interior-side surface of the outer pane and the outer surface of the inner pane are connected to one another via a thermoplastic intermediate layer, and wherein
the windshield comprises at least a first partial region, in which a transparent cover print comprising enamel is applied to the outer pane and/or inner pane,
the first partial region is arranged along the engine edge and extends from the engine edge in a direction of the roof edge of the windshield,
the first partial region with a transparent cover print projects at least partially into the A field of view of the windshield according to ECE-R 43, and
the windshield has a transmission of at least 70% in the visible range of the a light spectrum in the first partial region, at least in portions.

2. The windshield according to claim 1, wherein the first partial region takes up 10% to 100% of a total area of the windshield.

3. The windshield according to claim 1, wherein the first partial region extends at least in portions from the engine edge of the windshield by an amount in the direction of the roof edge of the windshield that corresponds to 10% to 90% of a height of the windshield.

4. The windshield according to claim 1, wherein the transparent cover print is colorless.

5. The windshield according to claim 1, wherein the transparent cover print is applied to the interior-side surface of the outer pane and/or to the interior-side surface of the inner pane.

6. The windshield according to claim 1, wherein the transparent cover print comprises print regions and at least one non-print region.

7. The windshield according to claim 6, wherein the print regions take up a proportion of 1% to 60% of a total area of the first partial region and form a regular or irregular pattern.

8. The windshield according to claim 6, wherein the print regions form a regular or irregular pattern, and print regions adjacent to one another have an average distance from 1 cm to 50 cm, wherein adjacent points of the print regions have a distance from 1 cm to 50 cm.

9. The windshield according to claim 1, wherein the transparent cover print has a printed enamel containing SiO₂.

10. The windshield according to claim 9, wherein the printed enamel has a porous structure, and wherein a pore size of the porous structure is 0.5 μm to 5 μm.

11. The windshield according to claim 1, wherein the thermoplastic intermediate layer comprises polyvinyl butyral (PVB), polyurethane (PU), ionomers and/or ethylene vinyl acetate (EVA).

12. The windshield according to claim 1, wherein the first pane and the second pane in each case have a thickness of 0.8 mm to 2.5 mm.

13. A method for producing a windshield according to claim 1, comprising:
a) providing an outer pane or an inner pane,
b) placing a thermoplastic intermediate layer onto the outer pane or the inner pane,
c) closing off the layer stack having an inner pane or an outer pane, and
d) laminating the layer stack composed of at least the outer pane, thermoplastic intermediate layer and inner pane to form a windshield,
wherein a transparent cover print is applied to the outer pane and/or the inner pane.

14. The method according to claim 13, wherein the transparent cover print is applied prior to step a) on the interior-side surface of the outer pane and/or on the interior-side surface of the inner pane.

15. A method comprising providing a windshield according to claim 1 in a motor vehicle.

16. The windshield according to claim 2, wherein the first partial region takes up 20% to 90% of the total area of the windshield.

17. The windshield according to claim 3, wherein the first partial region extends at least in portions from the engine edge of the windshield by an amount in the direction of the roof edge of the windshield that corresponds to 20% to 70% of the height of the windshield.

18. The windshield according to claim 4, wherein the transparent cover print is transparent or translucent, and has a transmission of at least 20% of visible light.

19. The windshield according to claim 6, wherein the print regions are designed to be punctiform, elliptical, cross-shaped or rectangular and are surrounded by the at least one non-print region.

20. The windshield according to claim 8, wherein the print regions adjacent to one another have an average distance from 2 cm to 30 cm, and the print regions form a regular dot pattern.
